(19) United States
(12) Patent Application Publication
(10) Pub. No.: US 2024/0278743 A1
(43) Pub. Date: Aug. 22, 2024

(54) Seat Belt Buckle Airbag Deactivation System

(71) Applicant: Textron Aviation Inc., Wichita, KS (US)

(72) Inventor: Dean Ross Gonzalez, Park City, KS (US)

(21) Appl. No.: 18/429,389

(22) Filed: Jan. 31, 2024

Related U.S. Application Data
(60) Provisional application No. 63/485,902, filed on Feb. 18, 2023.

(51) Int. Cl. B60R 21/015

(52) U.S. Cl. CPC B60R 21/01546

(57) ABSTRACT

A system and a method for allowing a passenger to deactivate a seatbelt deployed airbag system. A manual switch is provided in the airbag circuit that allows the airbag to be inactive. The switch is physically located on the inside surface of the buckle facing the occupant. More specifically, the switch is included in a recessed area formed in the inside surface underneath a removable cover.

### CROSS-REFERENCE TO RELATED APPLICATIONS

This application claims the benefit of U.S. Provisional Patent Application No. 63/485,902, filed Feb. 18, 2023, the entire contents thereof are herein incorporated by reference.

### BACKGROUND OF THE INVENTION

### 1. Field

The disclosed embodiments relate generally to the field of aircraft safety-related systems. More specifically, the disclosed embodiments relate to the field of seat belt technologies.

### 2. Description of the Related Art

It is known in the art to implement airbags into vehicles and to enable the deactivation of the airbags upon the presence of a child in a vehicle seat.

U.S. Patent Application Publication No. 2003/0193176 made by Ott et al. discloses a side airbag which deactivates when rear door child lock is engaged. U.S. Pat. No. 11,148,627 discloses the automatic deactivation of an airbag when a sensor detects a child seat has been installed.

U.S. Pat. No. 6,007,093 issued to Bechtle et al. discloses an airbag system where a central triggering unit receives an indication when an add-on belt system is buckled.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a system for aircraft, the system including: a seat belt for an aircraft seat; a buckle; a first switch included in a circuit between the buckle and a controller, the first switch being configured to be in a closed state upon a connection of the seat belt to the buckle; a second switch included in the circuit, the switch being configured to be manually switched to optionally open the circuit even if the first switch is in a closed state; the controller configured to recognize if the circuit is closed, and allowing actuation of an airbag proximate the seat only if the circuit is closed.

In some embodiments, the techniques described herein relate to an airbag system for aircraft, the system including: a seat belt including a buckle wherein the buckle includes a recessed area; a first switch included in a circuit between the buckle and a controller, the first switch being configured to be in a closed state upon a connection of the seat belt to the buckle; a physically operated switch included in the circuit between the buckle and the controller, the physically operated switch configured to be in one of an open state or a closed state depending on a manual setting; the controller configured to recognize current flow through the circuit, and allowing actuation of an airbag configured within a seat belt if the circuit is closed.

In some embodiments, the techniques described herein relate to a method for triggering airbag deployment on an aircraft, the method including: forming a circuit wherein the circuit includes a first switch and a second switch; introducing an electric current to the circuit; determining whether there is continuity in the circuit based upon if the electric current flows through the circuit; determining if the electric current is received, the circuit is closed and determining if the electric current is not received, the circuit is open; activating an airbag system if the circuit is closed; and deactivating the airbag system if the circuit is open.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of an embodiment of the seat belt buckle system in an example environment;

FIG. 2 is a perspective view showing the front side of the buckle system of FIG. 1;

FIG. 3 is a perspective view of a back side of the buckle system of FIGS. 1 and 2;

FIG. 4A is an exploded view of the buckle system shown in FIG. 3 showing a cover removed to reveal a switch which was concealed in FIG. 3;

FIG. 4B is a breakout view showing the switch arrangement area in FIG. 4A in more detail;

FIG. 5A is a schematic circuit diagram showing the electrical system supporting the buckle;

FIG. 5B is a diagram showing physical components of the system;

FIG. 6 is a flow diagram showing an embodiment of processes running on the controller;

FIG. 7 is a perspective view from front, down, and left of a seat belt strap of the buckle system of FIG. 1 in an embodiment;

FIG. 8 is a perspective view from down, left and the rear of the buckle system of FIG. 1 connected to an airbag system;

FIG. 9 is a close-up perspective view from front right of the buckle system of FIG. 1 revealing a wire harness connection used along with the airbag system of FIG. 8 in embodiments; and

FIG. 10 is a schematic circuit diagram showing an embodiment of an electrical system which could be used to support the operations of the buckle system of FIG. 1 in embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

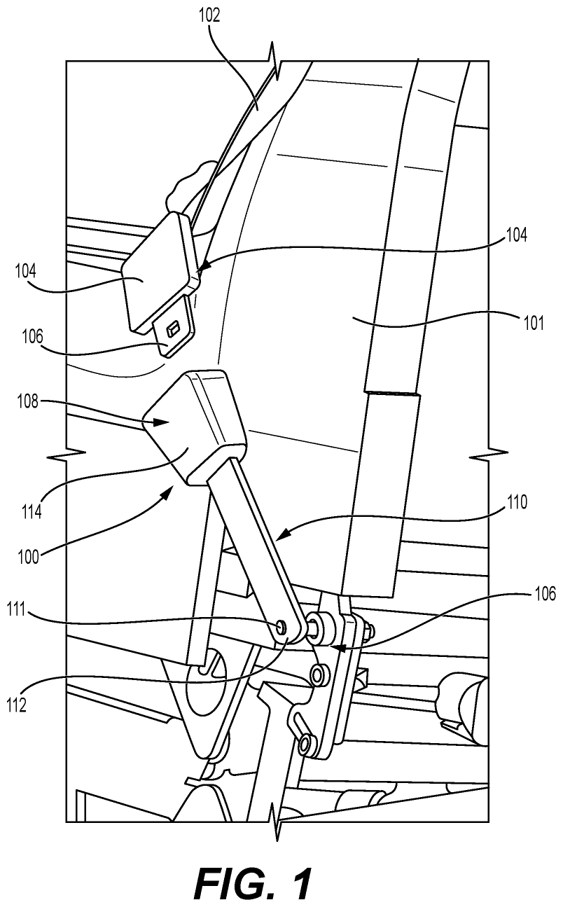

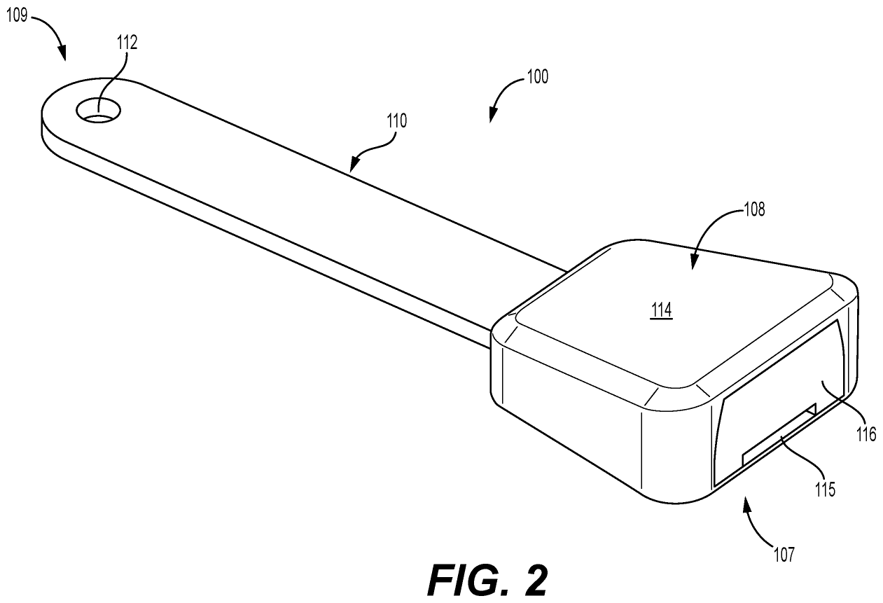

FIG. 1 shows an aircraft environment 100 in which the seat belt buckle airbag activation system may be utilized. In embodiments, the aircraft environment 100 includes an aircraft seat 101 equipped with a seat belt 102. The seat belt 102 includes a buckle 108 wherein a seat belt buckle airbag activation switch may be located. The seat belt 102 terminates at a seat belt connector 104 having a latch tongue 106. The latch tongue 106 is formed as a plate which is received by and secured into the buckle 108. The buckle 108 is presented at a first end of a semirigid strap 110. An aperture 112 exists at a second, opposite end of the strap 110. Aperture 112 receives a bolt to secure strap 110 to structures which are a part of the aircraft seat 101. The aperture 112 is used to secure a connection end 109 (see FIG. 2) of the strap onto structures 106 on the aircraft seat 101 by a bolt 111 in a known manner.

Referring to FIG. 2, a first side 114 of the buckle 108 would normally be exposed when the seat belt 102 is in use. A forward portion 107 of the buckle 108 includes a latch-tongue receiving mouth 115 that receives tongue 106. An inwardly-traveling outwardly-spring-biased latch release 116 (which is a known system) can be pushed in to accept the latch upon the tongue 106 when tongue 106 is inserted, then snap back to lock the buckle 108 to the seat belt connector 104. The latch release 116 can then be actuated by a user pushing the release 116 inward (relative to the buckle housing) to decouple the tongue 106 from mechanisms inside the buckle 108.

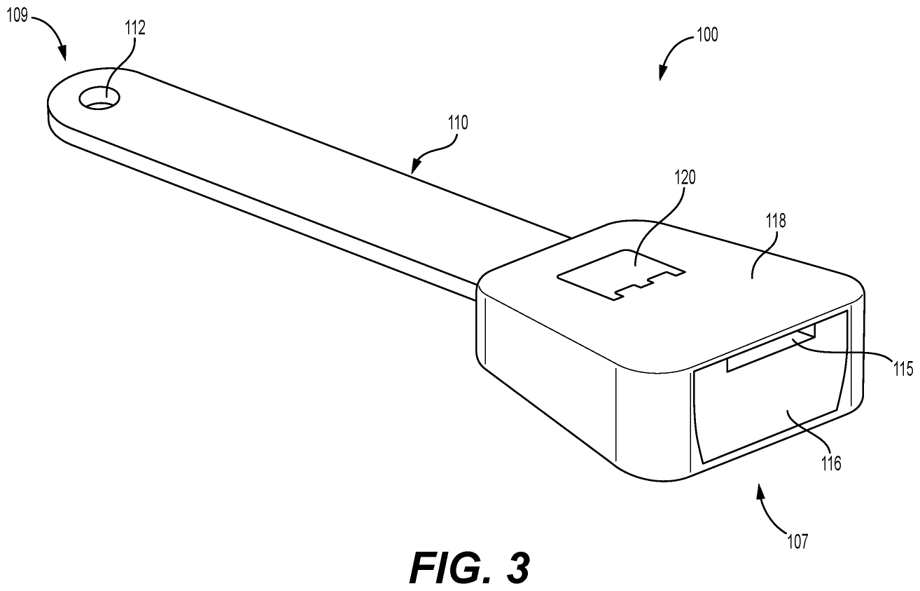

FIG. 3 shows a second side 118 of the buckle 108 faced opposite of the first side 114. The second side 118 is the side which contacts a user of the aircraft seat 101 when the seat belt 102 is in use by a passenger. Referring back to FIG. 1, the second side 118 faces toward the seat 101, so it is not visible in FIG. 1. Second side 118 is easily accessible, however, by simply pushing the buckle away from the seat 102. In embodiments, the strap 110 is fabricated from a material to have an extent of flexibility allowing stretching, while also having tensile strength which meets seat belt standards.

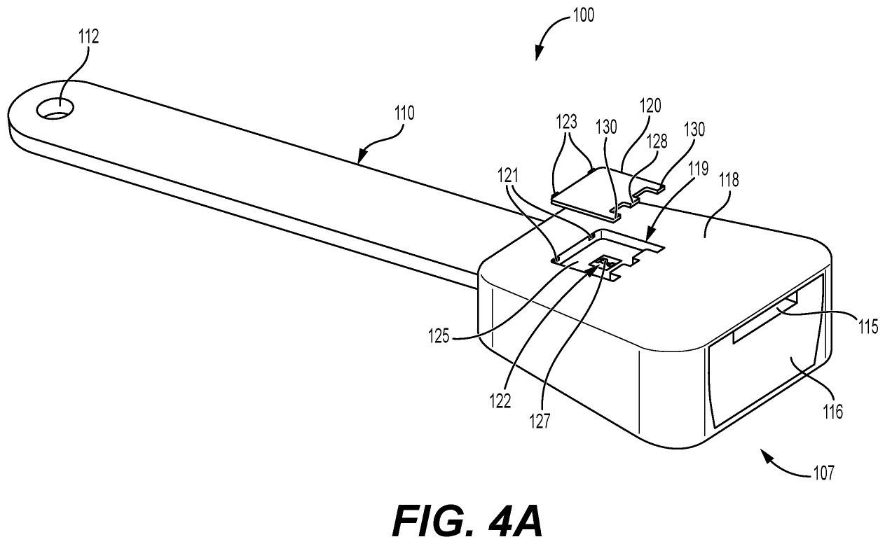

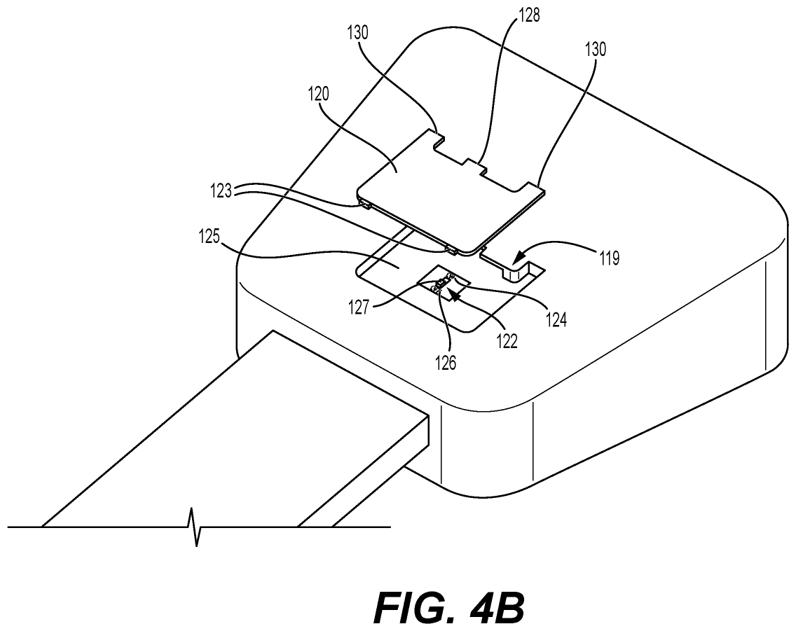

From the view shown in FIG. 3, a cover 120 is included on the second side 118 where the seat belt buckle airbag activation switch can be seen as it would appear in an attached state. When installed, the cover 120 conceals from above a physical switch 122 (FIG. 4A) which substantially allows a user to control the seat belt airbag activation or deactivation. In embodiments, the physical switch 122 includes a lever 127 which allows a user to manually operate the physical switch 122. Although the term “switch” is used extensively throughout this document, the term should not be defined in any over-limiting sense. The term if only intended to mean some form or system used for enabling the relevant airbag system from being active or not being active.

In embodiments, the cover 120 is configured to be removable from the second side 118 by prying or other removal techniques. Cover 120 could alternatively include a clip, fastener, screw, or other arrangement for making it removably securable to the second side 118 of the buckle 108.

The exploded view of FIG. 4A reveals a physical switch 122 and lever 127 as it appears (it is normally concealed) when the cover 120 is removed by a user, and FIG. 4B shows a breakout blowup detail of the switch arrangement area 119. The switch arrangement area 119 is a recessed area, recessed into the buckle 108 and is covered when the cover 120 is attached to the buckle 108 (as shown in FIG. 3). The cover 120 substantially protects the lever 127 of the physical switch 122 which extends upward from below to protrude from a switch arrangement area floor 125. Referring to FIG. 4B, switch 122, in embodiments, can be moved by a user by adjusting the lever 127 between a first “ON” position/setting 124, and a second “OFF” position/setting 126. The first setting or position 124 will create a closed circuit allowing for the flow of electricity, and the second setting or position 126 will create an open circuit stopping any electrical flow existing as will be discussed hereinafter. Also seen in FIG. 4B, is that the cover 120 includes two rearwardly extending prongs 123 each of which is configured to be received in reciprocating apertures 121 (see FIG. 4A) which together enable the cover 120 to be somewhat hingably connected about the prongs 123 during removal. The cover 120 is latched by a forwardly extending center catch 128 which is inside and in between two forwardly-extending portions 130. Catch 128 can be unlatched by a user to enable the cover to be rotated up and about the prongs 123, and then pulled out from the apertures 121 such that it is free as shown in FIG. 4B. In some embodiments, the cover 120 may be equipped with a screw or an alternative latch arrangement such that the cover 120 is removably securable to the second side 118 of the buckle 108.

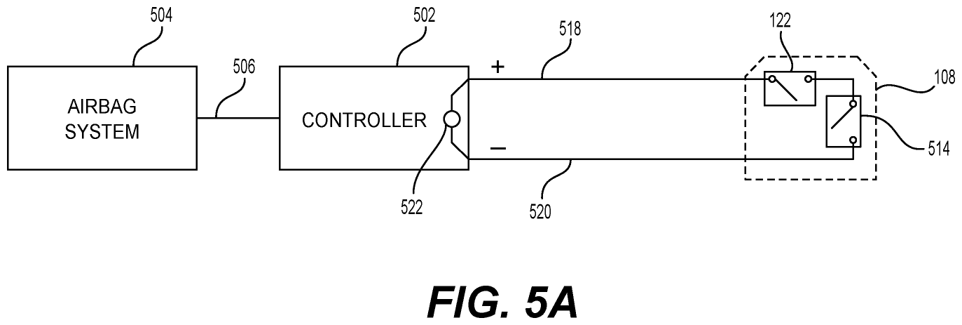

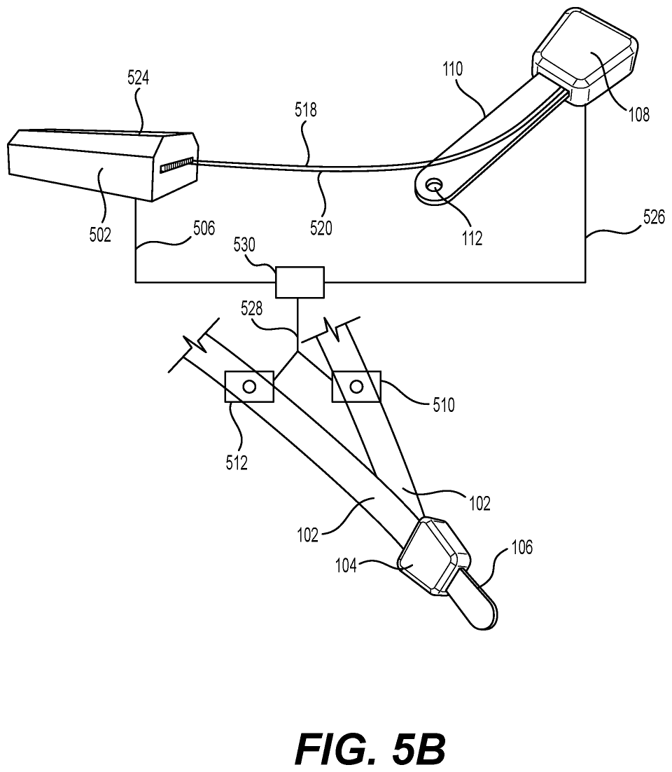

FIG. 5A shows a schematic diagram reflecting an embodiment of the seat belt buckle airbag activation system whereas FIG. 5B shows a physical representation of the switch system embodiment. Referring first to FIG. 5A, the buckle 108 is shown as being electrically connected to a controller 502 (e.g., which will include a computer or logic controller of some sort, as well as other electronics equipment in embodiments) which is then electrically connected to the airbag system 504 via one or more lines of communication 506.

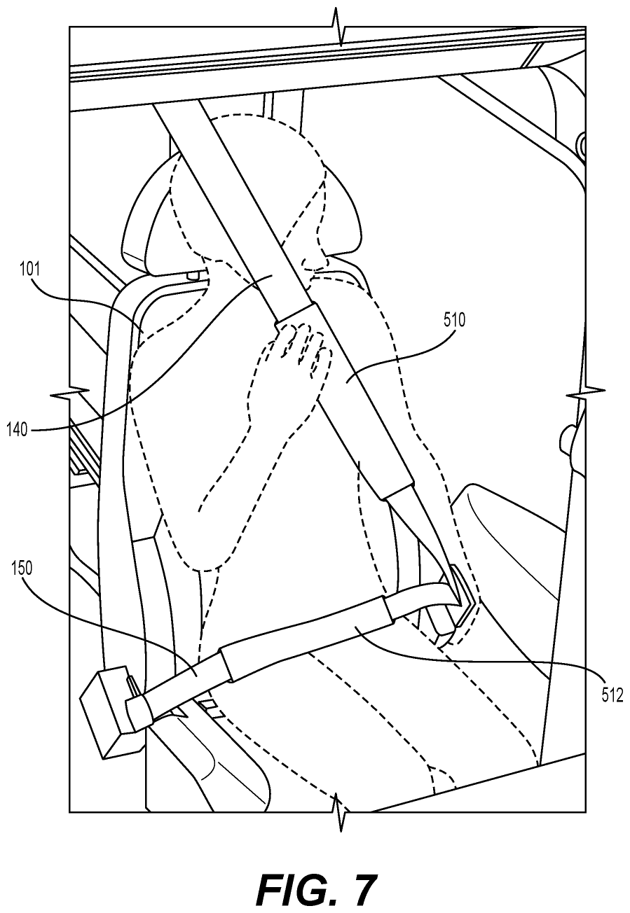

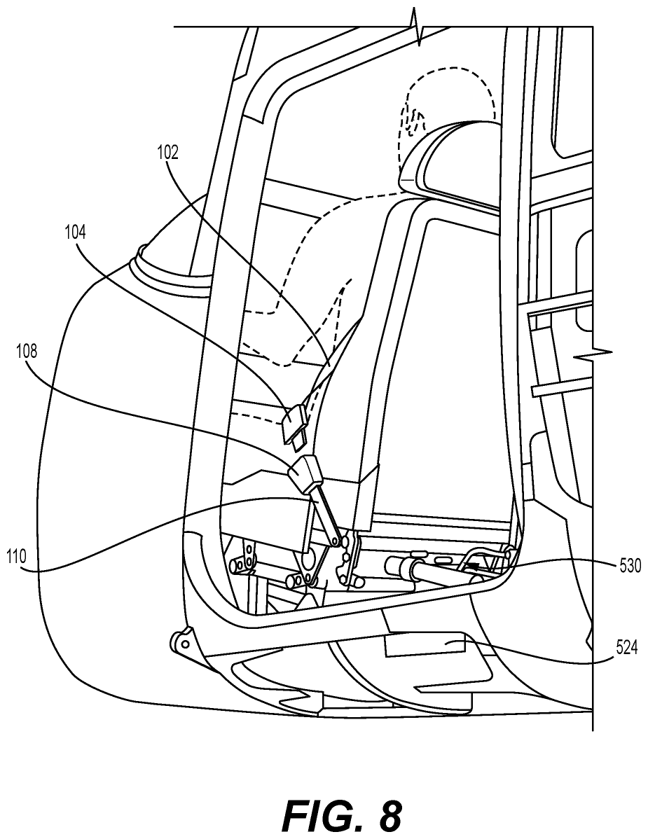

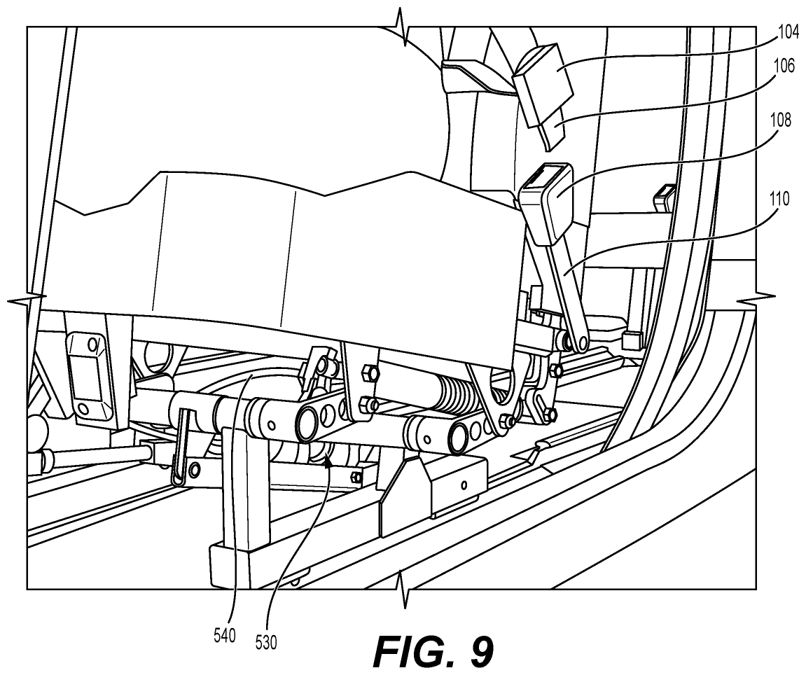

In embodiments, and with reference to FIG. 7, the airbag system 504 includes the deployable airbag 510 disposed on a shoulder seat belt strap 140 and a deployable airbag 512 disposed on a lap seat belt strap 150, the belt straps 140 and 150 being arranged in a three point seat belt system. The shoulder seat belt strap 140 is configured to be worn across a user's shoulder region and the lap seat belt strap 150 is configured to be worn across a user's waist when the user is seated in the aircraft seat 101. In embodiments, the airbag system 504 is disposed in both the shoulder seat belt strap 140 and lap seat belt strap 150. In other embodiments, the airbag system 504 may be disposed within either the shoulder seat belt strap 140 or the lap seat belt strap 150. In still other embodiments, a two point seat belt system including either the lap seat belt strap 150 and deployable airbag 512 or the shoulder seat belt strap 140 and deployable airbag 510 may be employed. Referring to FIG. 5B and FIG. 8 together, one or more seat belts 102 (which may include the shoulder seat belt strap 140 or lap seat belt strap 150 of FIG. 7) affixed to connector 104 include the deployable airbags 510 and 512. Whether airbags 510 and 512 are deployed or not (e.g., triggered by an accelerometer reading that exceeds a predetermined threshold being met by an event) will be determined by the open/closed of a first switch 514 (which already exists in some systems) and an additional second switch 122, which in embodiments is manually switchable using the lever 127 controlling the physical/second switch 122 (FIG. 4B). In FIG. 7, the airbags 510 and 512 are shown not deployed and are each contained in a pouch or sleeve incorporated with the lap seat belt strap 150 and shoulder seat belt strap 140. Both airbags 510 and 512 will either be inflated or not inflated and the orientation shown in FIG. 7 provides reference for uninflated airbags on a seat belt. An accelerometer or other instrument capable of providing a reading to inflate and deploy the airbag system 504 may be located under the seat within an electronic sensing box 524 which is operatively connected to an airbag inflator 530 (see FIGS. 8 and 9). In embodiments, the airbag inflator 530 is configured to send compressed air via the tube line 528 (FIG. 5B) to the airbags 510 and 512 in an event the electronic sensing box 524 detects a sudden change in acceleration has occurred (e.g. a crash). The controller 502 (FIG. 5A) embodied may be included within the electronic sensing box 524 which may be mounted in a concealed location in the aircraft proximate the aircraft seat 101, or even remotely connected/positioned. In embodiments, the airbag inflator 530 (included with the airbag system 504) is connected to the buckle 108 (disposed with the physical switch 122 and lever 127) with communication line 526 and is connected to the electronic sensing box 524 with the communication line 506. The system is designed such that the position of lever 127 controlling switch 122 will serve as an additional way for a user to deactivate the airbags 510 and 512. In one instance, a user can use the lever 127 of switch 122 to manually deactivate the airbag system 504 and airbags 510 and 512 when a child or child seat is in use. In yet other embodiments, additional switch 122, instead of being manually activated by an on/off switch (i.e. lever 127) in the buckle as disclosed herein could instead be operated by another switching means (e.g., an electronically actuated switch located in the buckle or remotely proximate the passenger).

The purpose of the buckle first switch 514 is to enable the system (e.g., controller 502) to recognize whether connector tongue 106 is locked inside the buckle 108 or not. A locked position is an indication that a passenger is in the aircraft seat 101. Thus, the buckled state justifies arming the airbag so that it is ready for deployment. An unbuckled state indicates that the aircraft seat 101 is not occupied, and thus, there should not be an airbag deployment when a rapid acceleration change is recognized by the electronic sensing box 524.

Referring to FIG. 5A, the physical lever 127 controls switch 122 which may open or close the circuit and serves as a manual method of deactivating the airbag system 504 even though a buckling between the buckle 108 and the seat belt connector 104 has occurred. This might be advantageous, in one instance when a child is seated in the aircraft seat 101 due to the fact that airbags are not desirable for use, or in another instance airbags may be deactivated due to incompatibility with child seats and the great force created by deployment, etc. In the instances above or in other instances, it may be desirable for a user to turn the airbag system off in certain circumstances when the seat belt 102 is buckled.

Referring to FIG. 5A, when the tongue 106 of the seat belt connector 104 is slid into the latch-tongue receiving mouth 115 of the buckle 108 (i.e. the seat belt 102 is buckled), the first switch 514 will be closed. If the lever 127 of the physical switch 122 is switched to the “ON”/first position 124 the second/physical switch 122 will be closed. If the lever 127 controlling the physical switch 122 is switched to the “OFF”/second position 126 the second switch 122 will be open. When both the first switch 514 and the second switch 122 are closed the circuit is closed/completed, and current will be able to travel through the circuit. If either the first switch 514 or the second switch 122 are open, the circuit will be open and current will be unable to travel through the circuit. In normal operating circumstances (e.g. when a user, that is not a child, is seated in the aircraft seat 101) the second switch 122 will be in the closed position (i.e. the lever 127 is moved to the “ON”/first position 124), and a buckling between the seat belt connector 104 and buckle 108 will cause the circuit to be completed such that the airbag system 504 and airbags 510 and 512 are active. In other operating circumstances (e.g. when a user that is a child is seated in the aircraft seat 101) the second switch 122 will be in the open position (i.e. the lever 127 is moved to the “OFF”/second position 126), and a buckling between the seat belt connector 104 and the buckle 108 will not cause the circuit to be completed and the airbag system 504 and airbags 510 and 512 will not be active. The circuit includes a line 518 going to the positive connection of the controller 502, as well as a return line 520 which extends from the negative connection of the controller 502 to the buckle 108. A circuit measuring sensor 522 or other component is located with or associated with the controller 502, which may include a computer/processing component. The sensor 522 provides the controller 502 with a reading to determine whether the circuit is open or closed (i.e. whether an electrical connection is able to be made through the buckle 108). FIG. 5A shows both the first switch 514 and the second switch 122 in open condition.

Based on the circuit measuring sensor 522 reading, the controller 502 will be configured to allow the airbag system 504 to be active or inactive based on the state of the circuit, e.g., if circuit continuity exists. In some embodiments, continuity of the overall circuit detected by the controller 502 will be used to determine an airbag 510/512 status. Overall continuity would occur where both switches 514 and 122 are closed, thus the opposite of what is shown in FIG. 5A where both switches 514 and 122 are open. Continuity of the circuit will allow for the airbag system 504 to be active/armed. If an open circuit exists, e.g., where either of switches 122 or 518 are open continuity will not exist. FIG. 5A shows both switches in an open position, but if either is open, continuity will terminate. Any termination of continuity will disarm/deactivate the airbag system 504. In alternative embodiments, a sensing of electrical continuity by controller 502 resulting from a closed circuit will not allow for deployment (e.g., by inflation), and a sensing by the controller 502 of a lack of electrical continuity from an open circuit will allow inflation.

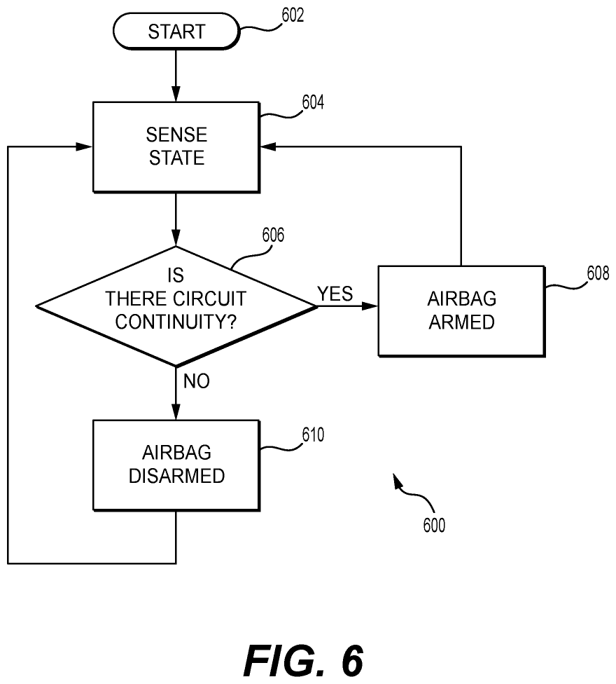

FIG. 6 shows a process 600 which might be employed by a logic controller, computer processor, or other computing device existing in controller 502 to trigger airbag system 504 deployment depending on whether the circuit made between the buckle 108 and controller 502 is open or closed. Beginning from a start 602 (which might be triggered by an initiation of other aircraft systems) the process moves on to a step 604 where continuity of the circuit including switches 514 and 122 as well as lines 518 and 520 exists. The controller 502 using subcomponent 522 will, in embodiments, introduce potential across lines 518 and 520, and then measure for amperage. A detection of electrical flow will indicate a closed circuit wherein both the switches 514 and 122 are closed, and a detection of no amperage will indicate an open circuit wherein one or both of the switches 514 and 122 are opened.

This determination of continuity is made in the next query step 606, and where the controller 502 determines if the circuit is closed (i.e. there is circuit continuity), moves on to a step 608 where the airbag system 504 is maintained in an “ON”/active state in a step 608 where an accelerometer reading representing an impact will result in an airbag deployment (e.g., signals are sent through lines of communication 506 and 526 to deploy bags 510 and 512). If, in query step 606 a determination is made that the circuit is open (i.e. there is not circuit continuity) the process moves on to a step 610 where the airbag system 504 is maintained in an “OFF”/deactivated state and will not be deployed by the controller 502 regardless of any accelerometer readings. Regardless of whether steps 608 or 610 are encountered, the process returns to the sensing step 604 such that a continuous loop is repeated until shut down.

It should be noted that the opposite arrangement where the existence of continuity sensed by the controller 502 results in disarming the airbag and a sensed break in continuity arms the airbag could also exist and still fall within the broad aspects of the disclosed embodiments.

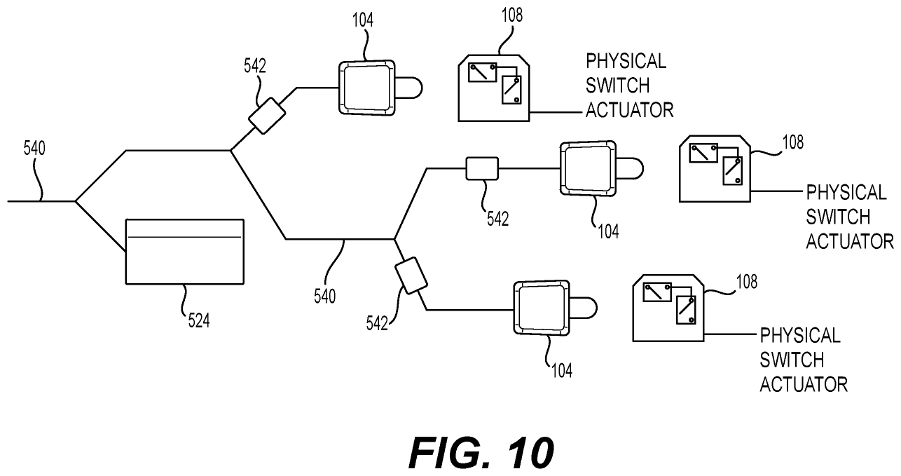

In some embodiments and physically shown in FIG. 9, numerous airbag systems 504 each configured with an aircraft seat 101 may be operatively connected to one another using a wire harness 540. FIG. 10 shows a diagram schematic of separate airbag systems 504 configured with three aircraft seats 101 connected together using the wire harness 540. The wire harness 540 is connected to the electronic sensing box 524 and connects to airbags 542 (i.e. either shoulder seat belt strap 140 airbag 510 or lap seat belt strap 150 airbag 512 or both). The seat belt connector 104 and the buckle 108 are disconnected in FIG. 10, but may be connected to possibly activate the shoulder seat belt strap 140 and lap seat belt strap 150 if the lever 127 controlling the physical switch 122 is switched to the “ON”/first position 124. The wire harness 540 substantially connects the airbags 542 disposed on each seat belt 102 of separate aircraft seats 101 together such that a trigger by the controller 502 of the electronic sensing box 524 will activate the airbags 542 configured with numerous different seats on the aircraft, while still being able to individually control whether an airbag 542 will deploy on a given aircraft seat 101 using the lever 127 controlling physical switch 122.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A system for aircraft, the system comprising:
a seat belt for an aircraft seat;
a buckle;
a first switch included in a circuit between the buckle and a controller, the first switch being configured to be in a closed state upon a connection of the seat belt to the buckle;
a second switch included in the circuit, the switch being configured to be manually switched to optionally open the circuit even if the first switch is in a closed state;
the controller configured to recognize if the circuit is closed, and allowing actuation of an airbag proximate the seat only if the circuit is closed.

2. The system of claim 1 wherein the second switch is on the buckle.

3. The system of claim 2 wherein the second switch is concealed inside the buckle by a cover.

4. The system of claim 3 wherein the second switch includes a lever included in a recessed area covered by the cover, the lever being manually operated by a user when the cover is removed.

5. The system of claim 4 wherein the cover is removably securable on the buckle.

6. The system of claim 5 wherein the cover includes prongs and a center catch configured to engage and become secure in the buckle.

7. The system of claim 1 wherein the airbag is located in the seat belt.

8. The system of claim 1 wherein the first switch depends on whether a latch-tongue of the seat belt is inserted and latched into the buckle and secures the seat belt to the buckle.

9. The system of claim 1 wherein the buckle is attached to a semirigid strap and the semirigid strap is bolted to the aircraft seat.

10. An airbag system for aircraft, the system comprising:
a seat belt including a buckle wherein the buckle includes a recessed area;
a first switch included in a circuit between the buckle and a controller, the first switch being configured to be in a closed state upon a connection of the seat belt to the buckle;
a physically operated switch included in the circuit between the buckle and the controller, the physically operated switch configured to be in one of an open state or a closed state depending on a manual setting;
the controller configured to recognize current flow through the circuit, and allowing actuation of an airbag configured within a seat belt if the circuit is closed.

11. The system of claim 10 wherein the physically operated switch is manually controlled by a lever configured to be switched between a first manual setting and a second manual setting.

12. The system of claim 11 wherein the lever in a first manual setting closes the circuit and the lever in a second manual setting opens the circuit.

13. The system of claim 11 wherein the lever protrudes from a switch arrangement area floor, and the switch arrangement area floor is recessed within the buckle and covered by a removable cover.

14. The system of claim 10 wherein a first airbag is configured with a shoulder seat belt strap and a second airbag is configured with a lap seat belt strap.

15. The system of claim 14 wherein a tube line connects from the first airbag and the second airbag to an airbag inflator and is able to carry air from the airbag inflator to the first airbag and second airbag.

16. The system of claim 10 wherein an electronic sensing box includes the controller and is communicatively connected to the airbag inflator, and the electronic sensing box is configured to detect when a sudden change in acceleration has occurred.

17. The system of claim 16 wherein when a sudden change in acceleration is detected, the electronic sensing box communicates with the airbag inflator to inflate the first airbag and the second airbag.

18. A method for triggering airbag deployment on an aircraft, the method comprising:
forming a circuit wherein the circuit includes a first switch and a second switch;
introducing an electric current to the circuit;
determining whether there is continuity in the circuit based upon if the electric current flows through the circuit;
determining if the electric current is received, the circuit is closed and determining if the electric current is not received, the circuit is open;
activating an airbag system if the circuit is closed; and
deactivating the airbag system if the circuit is open.

19. The method of claim 18 including configuring at least one airbag in a seat belt.

20. The method of claim 18 including closing the circuit by closing the first switch when a latch tongue inserts into a seat belt buckle, and closing the second switch by moving a manually operated lever.
